(19) United States
(12) Patent Application Publication
(10) Pub. No.: US 2018/0241105 A1
(43) Pub. Date: Aug. 23, 2018

(54) Battery Fan System

(71) Applicant: East Penn Manufacturing Co., Lyon Station, PA (US)

(72) Inventor: Michael Thomas Bieber, Emmaus, PA (US)

(73) Assignee: East Penn Manufacturing Co., Lyon Station, PA (US)

(21) Appl. No.: 15/440,731

(22) Filed: Feb. 23, 2017

(51) Int. Cl. H01M 10/6563; H01M 10/613; H01M 10/63; H01M 10/6566

(52) U.S. Cl. CPC H01M 10/6563; H01M 10/6566; H01M 10/63; H01M 10/613

(57) ABSTRACT

A battery fan system is disclosed. The battery fan system has a frame having a plurality of channels disposed between a plurality of cell receiving spaces and a linear fan assembly having a linear fan longitudinally aligned with a first end of one of the plurality of channels.

### FIELD OF THE INVENTION

The invention relates to a fan system, and more particularly, to a fan system for cooling a battery.

### BACKGROUND

Batteries having interconnected battery cells used to supply electrical power are known in the art. In certain battery applications, such as batteries used to power industrial equipment, high levels of battery power are required, and the batteries produce correspondingly high levels of heat. Heat produced during operation can damage the battery, degrading the performance and decreasing the overall life of the battery.

Battery cooling systems have been developed to address the heat generated during operation. Known battery cooling systems attach a fan assembly to an exterior of a frame containing the battery cells, and using fans within the fan assembly, blow air through channels in the frame to cool the battery cells. Attaching the fan assembly to the exterior of the frame, however, exposes the fans to damage, decreasing the usefulness of the system. Furthermore, the fans produce a flow of air that travels through the fan assembly before entering the channels of the frame. Known fan assemblies consequently slow and truncate the flow of air produced by the fans contained within, impairing heat exchanging capability and thus providing sub-optimal cooling to the battery.

### SUMMARY

An object of the invention, among others, is to provide a battery fan system which optimizes cooling while protecting fans of the battery fan system. The disclosed battery fan system has a frame having a plurality of channels disposed between a plurality of cell receiving spaces and a linear fan assembly having a linear fan longitudinally aligned with a first end of one of the plurality of channels.

### BRIEF DESCRIPTION OF THE DRAWINGS

The invention will now be described by way of example with reference to the accompanying figures, of which:

FIG. 1 is a perspective view of a battery fan system according to the invention;

FIG. 2 is a perspective view of a frame and a plurality of linear fan assemblies of the battery fan system of FIG. 1;

FIG. 3 is a sectional perspective view of the frame and the plurality of linear fan assemblies of FIG. 2;

FIG. 4 is a sectional top view of the frame and the plurality of linear fan assemblies of FIG. 2;

FIG. 5 is a front view of a cell partition of the frame of FIG. 2;

FIG. 6 is a front view of a fan partition of the frame of FIG. 2;

FIG. 7 is a front view of one linear fan assembly of the plurality of linear fan assemblies of FIG. 2; and

FIG. 8 is a top view of a plurality of battery cells along with the frame and the plurality of linear fan assemblies of FIG. 2.

### DETAILED DESCRIPTION OF THE EMBODIMENTS

The invention is explained in greater detail below with reference to embodiments of a battery fan system. This invention may, however, be embodied in many different forms and should not be construed as limited to the embodiments set forth herein; rather, these embodiments are provided so that this disclosure will be thorough and complete and still fully convey the scope of the invention to those skilled in the art.

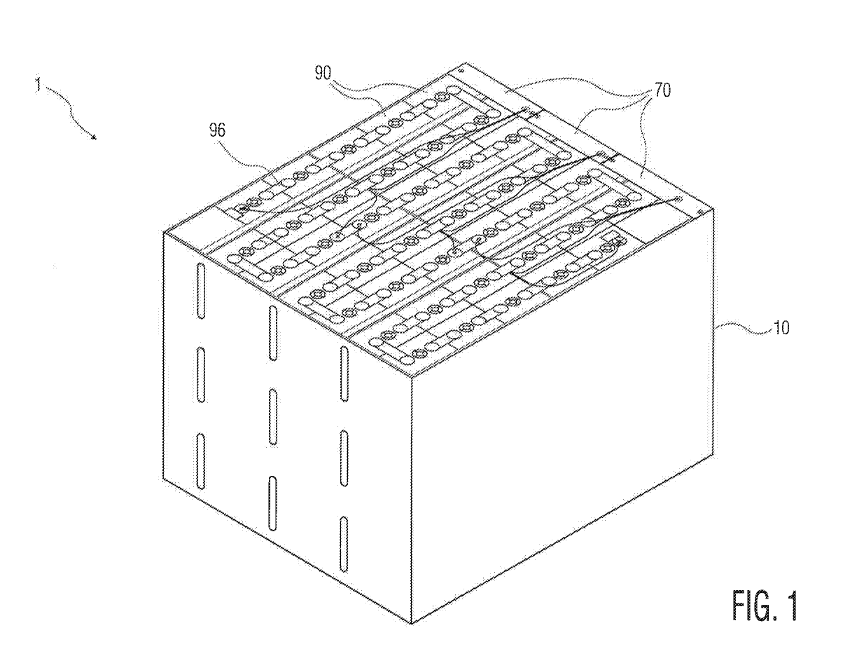

The battery fan system 1 is shown generally in FIG. 1. The battery fan system 1 includes a frame 10, a plurality of linear fan assemblies 70, and a plurality of battery cells 90. The major components of the invention will now be described in greater detail.

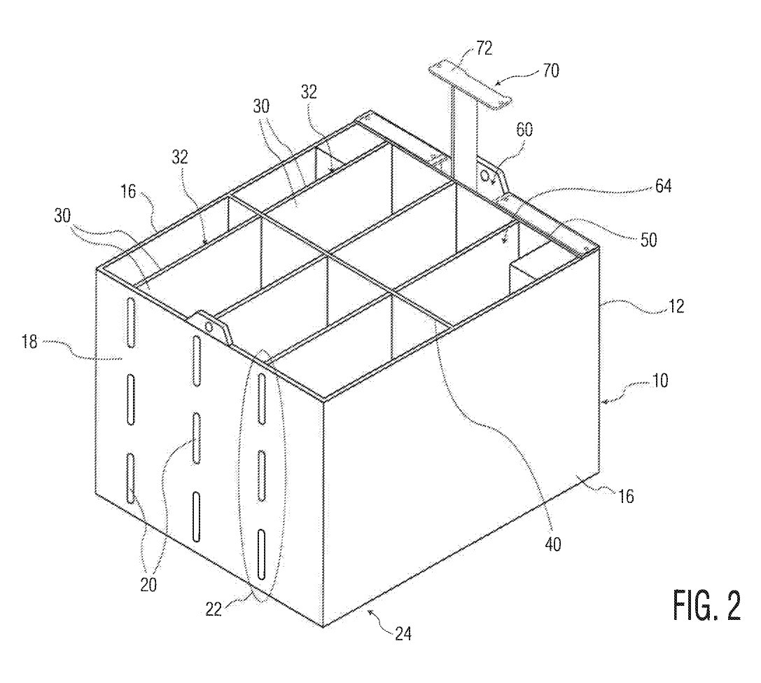

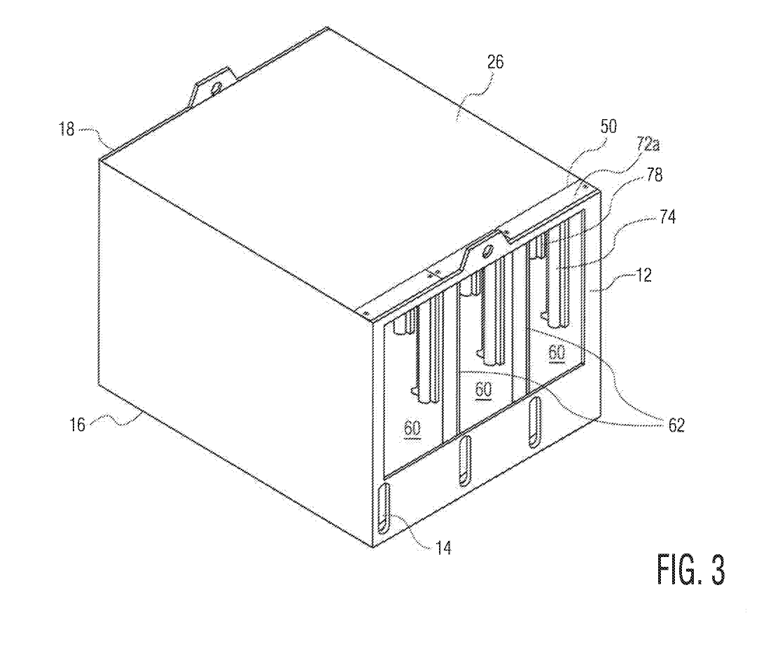

The frame 10, as shown in FIGS. 2-4, has a first wall 12 at a first end. The first wall 12, as shown in FIG. 3, has a plurality of inlet passageways 14 extending through the first wall 12. The inlet passageways 14 are disposed evenly spaced apart adjacent a bottom of the first wall 12. In the shown embodiment, the inlet passageways 14 have an elongated shape with curved ends. The inlet passageways 14 could alternatively have a rectangular shape, a circular shape, or other shapes known to those with ordinary skill in the art.

The frame 10, as shown in FIGS. 2-4, has a second wall 18 at an opposite second end. The second wall 18, as shown in FIG. 2, has a plurality of outlet passageways 20 extending through the second wall 18. In the shown embodiment, nine outlet passageways 20 are separated into three sets 22 of three outlet passageways 20. The outlet passageways 20 in each set 22 are linearly aligned between a bottom and a top of the second wall 18. Each set 22 of outlet passageways 20 is parallel to and evenly spaced apart from other sets 22 in a direction extending between opposite sides of the second wall 18. As would be understood by one with ordinary skill in the art, the number of outlet passageways 20, the number of sets 22 of outlet passageways 20, and the number of outlet passageways 20 in each set 22 could vary. In the shown embodiment, the outlet passageways 20 have an elongated shape with curved ends. The outlet passageways 20 could alternatively have a rectangular shape, a circular shape, or other shapes known to those with ordinary skill in the art.

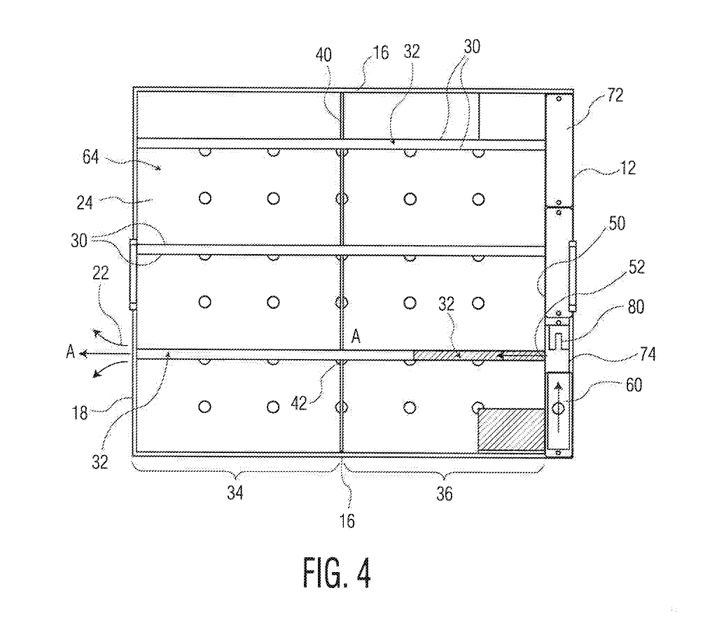

A pair of side walls 16, as shown in FIGS. 2-4, connect the first wall 12 and the second wall 18, with each side wall 16 connecting a side of the first wall 12 with a respective side of the second wall 18. A bottom wall 24, as shown in FIG. 4, connects a bottom of the first wall 12, a bottom of the second wall 18, and a bottom of each of the pair of side walls 16.

In the shown embodiment, the first wall 12 and the second wall 18 are square shaped, while the pair of side walls 16 and the bottom wall 22 are rectangular shaped. One with ordinary skill in the art would understand that the first wall 12, second wall 18, pair of side walls 16, and bottom wall 22 may be other shapes depending on the particular application of the frame 10. The first wall 12, second wall 18, pair of side walls 16, and bottom wall 22 may thus form a cube with an open top, a rectangular prism with an open top, or other three-dimensional shapes as would be understood by one with ordinary skill in the art.

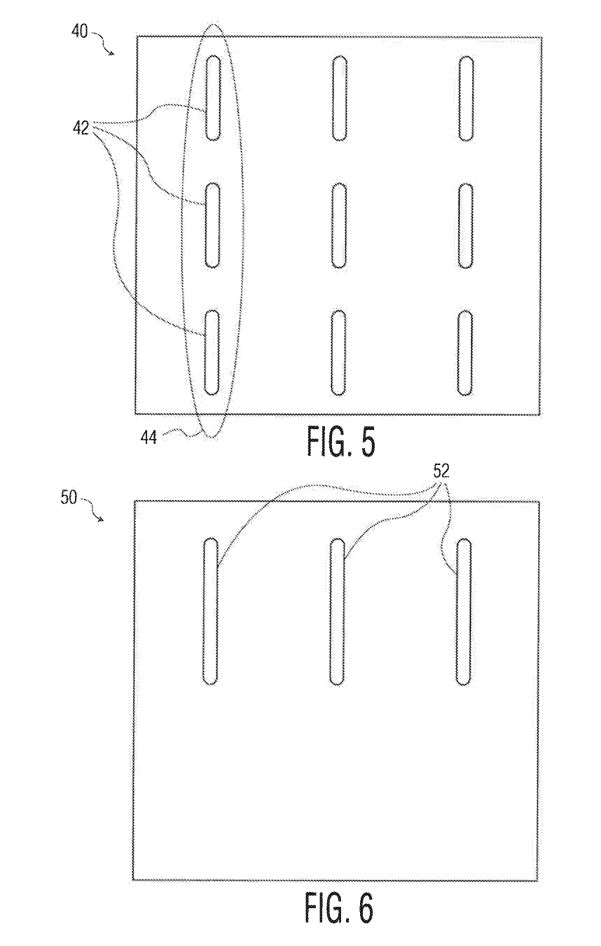

The frame 10, as shown in FIGS. 2, 4, and 5, also has a cell partition 40. The cell partition 40 is positioned parallel to and between the first wall 12 and the second wall 18, and in the shown embodiment, is disposed centrally between the first wall 12 and the second wall 18. Each side of the cell partition 40 is connected to one of the pair of side walls 16. The cell partition 40 has a same shape as the first wall 12 and the second wall 18 and, as shown in FIG. 5, may be formed similarly to the second wall 18. The cell partition 40 has a plurality of channel passageways 42 extending through the cell partition 40. In the embodiment shown in FIG. 5, nine channel passageways 42 are separated into three sets 44 of three channel passageways 42. The channel passageways 42 in each set 44 are linearly aligned between a bottom and a top of the cell partition 40. Each set 44 of channel passageways 42 is parallel to and evenly spaced apart from other sets 44 in a direction extending between opposite sides of the cell partition 40. As would be understood by one with ordinary skill in the art, the number of channel passageways 42, the number of sets 44 of channel passageways 42, and the number of channel passageways 42 in each set 44 could vary. In the shown embodiment, the channel passageways 42 have an elongated shape with curved ends. The channel passageways 42 could alternatively have a rectangular shape, a circular shape, or other shapes known to those with ordinary skill in the art.

The frame 10, as shown in FIGS. 2-4 and 6, also has a fan partition 50. The fan partition 50 is positioned parallel to and between the first wall 12 and the cell partition 40, and in the shown embodiment, is disposed adjacent the first wall 12. Each side of the fan partition 50 is connected to one of the pair of side walls 16. The fan partition 50 has a same shape as the first wall 12 and the second wall 18 and, as shown in FIG. 6, has a plurality of fan passageways 52 extending through the fan partition 50. The fan passageways 52 are disposed evenly spaced apart adjacent a top of the fan partition 50. In the shown embodiment, the fan passageways 52 have an elongated shape with curved ends. The fan passageways 52 could alternatively have a rectangular shape, a circular shape, or other shapes known to those with ordinary skill in the art.

The frame 10, as shown in FIGS. 2 and 4, also has a plurality of channel partitions 30. The channel partitions 30 have a same height as the pair of side walls 16 and extend parallel to the pair of side walls 16. A bottom of each channel partition 30 is connected to the bottom wall 24. The channel partitions 30 are disposed in pairs, forming a channel 32 between each pair of channel partitions 30.

A first set 34 of the pairs of channel partitions 30 has a first end connected to the cell partition 40 and an opposite second end connected to the second wall 18. As shown in FIG. 4, the channel 32 of each pair of channel partitions 30 in the first set 34 is aligned at the first end with one set 44 of channel passageways 42, and is aligned at the second end with one set 22 of outlet passageways 20. A second set 36 of the pairs of channel partitions 30 has a first end connected to the fan partition 50 and an opposite second end connected to the cell partition 40. As shown in FIG. 4, the channel 32 of each pair of channel partitions 30 of the second set 36 is aligned at the first end with one of the plurality of fan passageways 52, and is aligned at the second end with one set 44 of channel passageways 42. As shown in FIG. 2, the number of pairs of channel partitions 30 in the first set 34 corresponds to the number of sets 22 of outlet passageways 20 and the number of sets 44 of channel passageways 42. The number of pairs of channel partitions 30 in the second set 36 corresponds to the number of sets 44 of channel passageways 42 and the number of fan passageways 52.

As shown in FIGS. 2 and 3, a plurality of fan receiving spaces 60 are defined by the first wall 12, the fan partition 50, and portions of each of the pair of side walls 16. Each of the plurality of fan receiving spaces 60 is separated from others of the plurality of fan receiving spaces 60 by a plurality of supports 62. Each of the plurality of supports 62 has a same height as the pair of side walls 16, extends parallel to the pair of side walls 16, and has a first end connected to the first wall 12 and an opposite second end connected to the fan partition 50. The plurality of supports 62 are evenly spaced between the pair of side walls 16. The number of fan receiving spaces 60 corresponds to the number of inlet passageways 14.

As shown in FIGS. 2 and 4, a plurality of cell receiving spaces 64 are defined by the fan partition 50, the pair of side walls 16, the second wall 18, the plurality of channel partitions 30, and the cell partition 40. The pairs of channel partitions 30 and corresponding channels 32 are disposed between adjacent cell receiving spaces 64 in a direction extending between the pair of side walls 16. The cell partition 40 is disposed between adjacent cell receiving spaces 64 in a direction extending between the fan partition 50 and the second wall 18. The plurality of cell receiving spaces 64 are separated from the plurality of fan receiving spaces 60 by the fan partition 50.

The frame 10 also has a cover 26, as shown in FIG. 3. The cover 26 may be removably positioned to cover the plurality of cell receiving spaces 64 and extends between the first partition 50, the pair of side walls 16, and the second wall 18. The cover 26 may be removably fastened to the first partition 50, the pair of side walls 16, and the second wall 18 by an adhesive, screws, or other types of fasteners known to those with ordinary skill in the art.

All elements of the frame 10, including the first wall 12, the second wall 18, the pair of side walls 16, the bottom wall 24, the cover 26, the plurality of channel partitions 30, the cell partition 40, and the fan partition 50 are formed from the same material, and may be formed from a metal material.

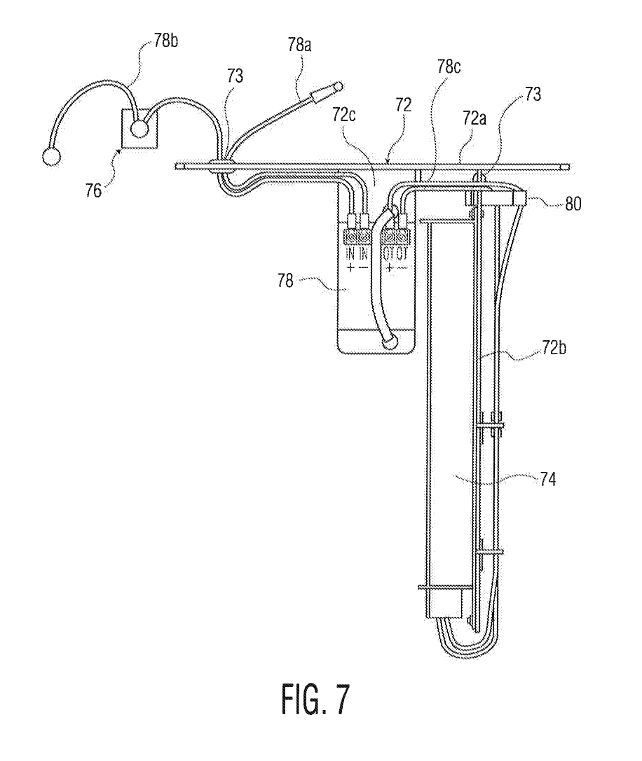

One of the plurality of linear fan assemblies 70 is shown in FIG. 7. The linear fan assembly 70 has a support plate 72, a linear fan 74, a thermostat 76, a power regulator 78, and a fuse 80.

The support plate 72 is formed in an approximate T-shape, having a first plate 72a, a second plate 72b extending perpendicularly from the first plate 72a, and a third plate 72c extending perpendicularly from the first plate 72a and positioned perpendicular with respect to the second plate 72b. In the shown embodiment, each of the first plate 72a, the second plate 72b, and the third plate 72c has an elongated rectangular shape, but as would be understood by one with ordinary skill in the art, the first plate 72a, the second plate 72b, and the third plate 72c could have other shapes. The first plate 72a, the second plate 72b, and the third plate 72c are formed from a same material as the elements of the frame 10, for example, a metal material.

The support plate 72 has a plurality of bushings 73. The plurality of bushings 73 are annular members formed of an insulative and flexible material, such as rubber. In the shown embodiment, one of the plurality of bushings 73 is disposed to extend through the first plate 72a and another of the plurality of bushings 73 is disposed to extend through the second plate 72b. The plurality of bushings 73 may alternatively be disposed in various positions on the support plate 72, as would be understood by one with ordinary skill in the art.

The linear fan 74 is a fan having an elongated shape, such as a crossflow fan, capable of emitting a linear air output.

The thermostat 76 is any thermostat known to those with ordinary skill in the art capable of comparing a detected temperature to a set point temperature and outputting a signal based on the comparison. The thermostat 76 may be covered by heat shrink tubing for protection.

The power regulator 78 is any regulator known to those with ordinary skill in the art capable of maintaining a constant voltage supply. The power regulator 78 has a negative input wire 78a, a positive input wire 78b, and a plurality of output wires 78c.

The fuse 80 is any fuse known to those with ordinary skill in the art capable of providing overcurrent protection.

As shown in FIG. 7, the linear fan 74 is aligned with and attached to the second plate 72b, and the fuse 80 is also attached to the second plate 72b. The power regulator 78 is attached to the third plate 72c. The linear fan 74, power regulator 78, and fuse 80 are all positioned to fit within a footprint of the first plate 72a projected in a direction along the length of the linear fan 74.

An input side of the power regulator 78 is electrically connected to the thermostat 76. The thermostat 76 is connected to and disposed between a first end and an opposite second end of the positive input wire 78b, the positive input wire 78b extending through one of the plurality of bushings 73 in the first plate 72a, with the second end of the positive input wire 78b connected to power regulator 78. The negative input wire 78a also extends through one of the plurality of bushings 73 in the first plate 72a and has a first end and an opposite second end, the second end of the negative input wire 78a connected to the power regulator 78. An output side of the power regulator 78 is electrically connected to the linear fan 74. A first end of each of the plurality of output wires 78c is connected to the power regulator 78, the plurality of output wires 78c extend through a bushing 73 in the second plate 72b, and the plurality of output wires 78c are connected through the fuse 80, each having a second end connected to the linear fan 74.

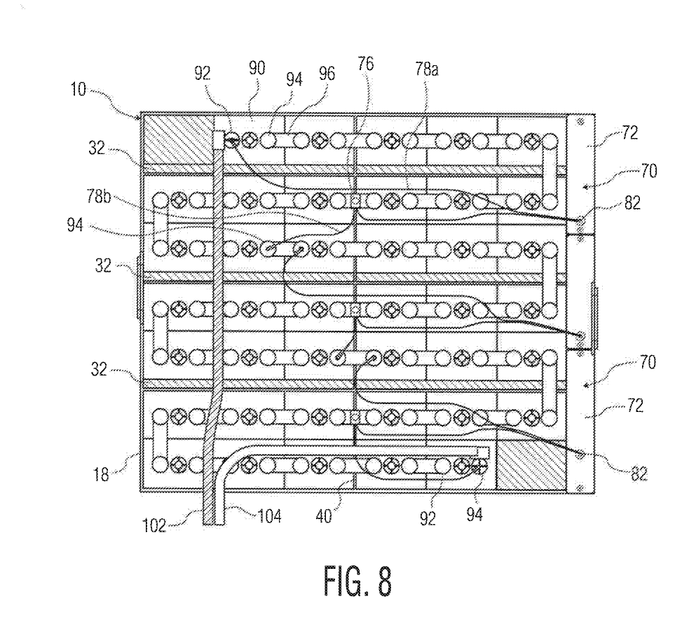

The plurality of battery cells 90 are shown in FIGS. 1 and 8. Each of the plurality of battery cells 90 is a type of battery cell known to those with ordinary skill in the art, each having an anode 92 and a cathode 94.

The assembly of the battery fan system 1 will now be described in greater detail with reference to FIGS. 1-4 and 8.

As shown in FIGS. 1, 2, and 8, the plurality of battery cells 90 are disposed in the plurality of cell receiving spaces 64. The anode 92 of each battery cell 90 is respectively connected to the cathode 94 of an adjacent battery cell 90 by a cell connector 96; as shown in FIG. 8, some of the cell connectors 96 are disposed to bridge a channel 32. As shown in FIG. 3, the cover 26 is removably disposed to cover the plurality of battery cells 90.

As shown in FIGS. 2 and 3, each linear fan assembly 70 is removably positioned in one of the plurality of fan receiving spaces 60. The first plate 72a of each linear fan assembly 70 is removably fastened to a top of the plurality of supports 62 and/or the pair of side walls 16 by screws, an adhesive, or other removable fasteners known to those with ordinary skill in the art. The first plate 72a of each linear fan assembly 70, when the linear fan assembly 70 is positioned in the fan receiving space 60 of the frame 10, also abuts the fan partition 50, the first wall 12, and an adjacent linear fan assembly 70 to fully cover the fan receiving space 60.

When the first plate 72a of the linear fan assembly 70 covers the fan receiving space 60 and is removably attached to the frame 10, as shown in FIG. 3, the linear fan 74, power regulator 78, and fuse 80 are positioned in the fan receiving space 60. A longitudinal axis of the linear fan 74 is aligned with one of the fan passageways 52, as shown in FIGS. 3 and 4, and is consequently also aligned with the first end of one of the channels 32 of the second set 36 of channel partitions 30. As shown in FIGS. 1 and 8, the negative input wire 78a and positive input wire 78b of each linear fan assembly 70 are connected to the plurality of battery cells 90. The first end of the negative input wire 78a is connected to the anode 92 of one of the plurality of battery cells 90. The first end of the positive input wire 78b is connected to the cathode 94 of one of the plurality of battery cells 90. The thermostat 76, connected between the first end and the second end of the positive input wire 78b, is disposed under a cell connector 96 among the plurality of battery cells 90.

The use of the battery fan system 1 will now be described in greater detail with reference to FIGS. 1, 4, and 8.

The plurality of battery cells 90 connected by the cell connectors 96 produce electrical power, and as shown in FIG. 8, may be connected to an external negative cable 102 and an external positive cable 104 to provide power to an external device, for example, industrial equipment requiring high levels of battery power.

The plurality of battery cells 90 produce heat during operation. For each linear fan assembly 70, the thermostat 76 senses a detected temperature and compares the detected temperature to a set point temperature set by a user. When the detected temperature exceeds the set point temperature, the thermostat 76 sends power at a battery output voltage through the positive input wire 78b and to the power regulator 78. The power regulator 78 receives the power at the battery output voltage from the positive input wire 78b and the negative input wire 78a, and regulates the power received at the battery output voltage to output power at a consistent voltage along the plurality of output wires 78c, regardless of the battery output voltage of the plurality of battery cells 90. The consistent voltage is determined by a voltage required by the linear fan 74. The power at the consistent voltage is transmitted along the plurality of output wires 78c through the fuse 80 and to the linear fan 74 to activate the linear fan 74. The fuse 80 provides overcurrent protection for the linear fan 74.

A path A of air when the linear fan 74 is activated is shown in FIG. 4. Air enters each fan receiving space 60 along path A through the corresponding inlet passageway 14. The air path A continues through the fan receiving space 60 and enters a side of the linear fan 74, exiting the linear fan 74 in a linear stream of air. Because the inlet passageway 14, as shown in FIG. 3, is positioned at an opposite end of the fan receiving space 60 from the linear fan 74 and is not aligned with the linear fan 74, the operation of the linear fan 74 does not disrupt the flow of air along path A into the inlet passageway 14 and through the fan receiving space 60.

As shown in FIG. 4, because the output of the linear fan 74 is aligned with the fan passageway 52, the air path A enters one channel 32 of the second set 36 of channel partitions 30. Due to the size and shape of the fan passageway 52, the air directly enters the channel 32 as a full linear stream; the output of the linear fan 74 directly communicates with the channel 32 of the second set 36 of channel partitions 30 and is not disrupted by the fan partition 50. The air path A continues along the channel 32 of the second set 36 of channel partitions 30 as a full linear stream of air, passes through one set 44 of channel passageways 42, and enters one channel 32 of the first set 34 of channel partitions 30. As the air passes through the channels 32 it absorbs the heat produced by the plurality of battery cells 90. The air path A exits the channel 32 of the first set 34 of channel partitions 30 at one set 22 of outlet passageways 20 to an exterior of the battery fan system 1. As the air exits the battery fan system 1, heat produced by the plurality of battery cells 90 is removed from the battery fan system 1. When the detected temperature drops below the set point temperature, the thermostat 76 interrupts power transmitted to the power regulator 78, which deactivates the linear fan 74.

Advantageously, in the battery fan system 1 according to the invention, because the linear fan 74 is aligned with the fan passageway 52 such that the output air of the linear fan 74 directly enters the channel 32 as a full linear stream, the air flow and corresponding heat exchange through the channel 32 is optimized for a given fan power. The battery fan system 1 thus optimizes cooling of the plurality of battery cells 90. Furthermore, because the fan receiving spaces 60 are formed by the frame 10, the plurality of linear fan assemblies 70 are positioned inside the frame 10 and are thus protected by the frame 10. The plurality of linear fan assemblies 70 are also removably secured to the frame 10, providing ease of maintenance while preventing tampering with the linear fans 74.

What is claimed is:

1. A battery fan system, comprising:
a frame having a plurality of channels disposed between a plurality of cell receiving spaces; and
a linear fan assembly having a linear fan longitudinally aligned with a first end of one of the plurality of channels.

2. The battery fan system of claim 1, wherein the linear fan is disposed within a fan receiving space of the frame.

3. The battery fan system of claim 2, wherein the fan receiving space is formed by the frame such that the linear fan assembly is positioned inside the frame.

4. The battery fan system of claim 3, wherein the frame has a first wall, a second wall, a pair of side walls connecting the first wall and the second wall, and a fan partition positioned parallel to and between the first wall and the second wall adjacent the first wall.

5. The battery fan system of claim 4, wherein the fan receiving space is defined by the first wall, the fan partition, and portions of each of the pair of side walls.

6. The battery fan system of claim 4, wherein each of the plurality of channels is defined by a pair of channel partitions extending between the fan partition and the second wall of the frame.

7. The battery fan system of claim 6, wherein the plurality of cell receiving spaces are defined by the fan partition, the pair of side walls, the second wall, and a plurality of channel partitions.

8. The battery fan system of claim 4, wherein the fan partition has a fan passageway extending through the fan partition.

9. The battery fan system of claim 8, wherein the linear fan is longitudinally aligned with the fan passageway.

10. The battery fan system of claim 9, wherein the fan passageway is positioned between the linear fan and the first end of one of the plurality of channels.

11. The battery fan system of claim 4, wherein the second wall has an outlet passageway extending through the second wall.

12. The battery fan system of claim 11, wherein the outlet passageway is aligned with a second end of one of the plurality of channels.

13. The battery fan system of claim 4, wherein the first wall has an inlet passageway extending through the first wall.

14. The battery fan system of claim 13, wherein the inlet passageway is positioned at an opposite end of the fan receiving space from the linear fan.

15. The battery fan system of claim 4, further comprising a cell partition positioned parallel to and between the fan partition and the second wall.

16. The battery fan system of claim 15, wherein the cell partition has a channel passageway extending through the cell partition, the channel passageway aligned with a second end of one of the plurality of channels and a first end of another of the plurality of channels.

17. The battery fan system of claim 1, wherein the linear fan assembly has a support plate removably attached to the frame.

18. The battery fan system of claim 17, wherein the linear fan is attached to the support plate.

19. The battery fan system of claim 17, wherein the linear fan assembly has a thermostat.

20. The battery fan system of claim 19, wherein the thermostat is disposed among a plurality of battery cells positioned in the plurality of cell receiving spaces.

21. The battery fan system of claim 20, wherein the linear fan assembly has a power regulator attached to the support plate and connected to the linear fan by a plurality of output wires.

22. The battery fan system of claim 21, wherein the power regulator is electrically connected to the plurality of battery cells by a negative input wire and a positive input wire extending through the support plate.

23. The battery fan system of claim 22, wherein the thermostat is connected to and disposed between a first end and an opposite second end of the positive input wire.

24. The battery fan system of claim 1, wherein the linear fan is a crossflow fan.

25. The battery fan system of claim 7, wherein the frame has a cover removably disposed to cover the plurality of cell receiving spaces.
